(19) United States
(12) Patent Application Publication
(10) Pub. No.: US 2005/0229591 A1
(43) Pub. Date: Oct. 20, 2005

(54) Gas compressor pollution control system and method

(76) Inventor: Allen W. McCulloch, Farmington, NM (US)

Correspondence Address: HAYNES AND BOONE, LLP, 901 MAIN STREET, SUITE 3100, DALLAS, TX, 75202, US

(21) Appl. No.: 10/827,587

(22) Filed: Apr. 19, 2004

(51) Int. Cl. F02B 33/44; F01N 5/04; F01N 3/00; F01N 3/10

(52) U.S. Cl. 60/307; 60/280; 60/288

(57) ABSTRACT

A pollution control system and method for a compressor for compressing gas, according to which a combustion engine is connected to the compressor for driving the compressor, and the products of combustion from the engine are passed into the flow line connecting the source of the gas to the compressor.

### BACKGROUND

This invention relates to a pollution control system and method for a gas compressor driven by an internal combustion engine.

Gas compressors are used in the oil and gas industry to increase the fluid pressure in the flow lines for the oils and gases. Many of these compressors are driven by internal combustion engines which are often powered by natural gas.

However, the exhaust, or flue, gases from the engine are usually vented to atmosphere causing excessive noise and particulate pollution. Also, since the combustion process is less than completely efficient, unspent fuel from the engine is also vented to atmosphere.

Therefore, what is needed is a system for reducing this type of pollution and recover the unspent fuel.

### BRIEF DESCRIPTION OF THE DRAWINGS

The drawing is a diagrammatic view of an embodiment of the invention.

### DETAILED DESCRIPTION

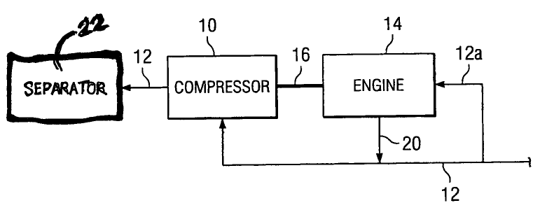

Referring to FIG. 1 of the drawings, the reference 10 refers, in general to a natural gas compressor connected in a main flow line 12 consisting of one or more pipes, conduits, risers, etc. The compressor 10 can be of any conventional type, such as a screw type, a rotary type, or the like.

It is understood that the flow line 12 extends from a gas well (not shown) and that gases recovered from the well pass in the flow line in the direction indicated by the flow arrows. The gases thus flow from the well, through the flow line 12, and to the compressor 10, which functions to compress the gases. The compressed gases then pass from the compressor 10 through the flow line 12 for some downstream treatment that will be described, before the gases pass to their ultimate destination.

The compressor 10 is driven by an internal combustion engine 14 in a manner to be described, and a branch line 12a extends from the flow line 12 upstream of the compressor 10 to the engine to pass a portion of the gases flowing in the flow line to the engine for powering the engine in a conventional manner. The engine 14 is conventional and, as such, generates products of combustion including exhaust, or flue gases. Also, since the combustion process in the engine 14 is less than completely efficient, unspent fuel, primarily in the form of hydrocarbons, is also present in the engine.

The engine 14 is connected by a drive shaft 16 to the compressor 10 so that, when activated, the engine 14 drives the compressor 10 in a conventional manner. The engine 14 has an inlet for receiving the gases from the branch line 12a which serve as fuel to power the engine, and an outlet for discharging the products of combustion and the unspent fuel. A pipe, or conduit, 20 connects the outlet of the engine 14 to the flow line 12 upstream of the compressor 10 and downstream from the branch line 12a. The pipe 20 passes the above products of combustion and any unspent fuel from the engine 14 to the flow line 12 where they are mixed with the well gases flowing through the flow line. The mixture thus passes into the compressor 10 and is compressed before the compressed mixture exits the compressor via the flow line 12.

The compressed mixture exiting from the compressor via the flow line 12 can be treated prior to being routed to its ultimate destination, or end user. For example, the H2O, CO2 and/or nitrogen from the products of combustion, and/or the unspent fuel in the mixture can be separated from the remaining portion of the, such as by resin re-absoption, or the like, and thus recaptured for reuse or disposal. This can be done in any conventional manner and at any convenient location, such as at the ultimate destination, or at a gas processing plant, a cryogenic plant, or the like, located between the compressor and the ultimate destination.

Thus, the products of combustion from the engine 14 are not discharged into the atmosphere, but rather are mixed with the well gases being processed, thus avoiding any noise or particle pollution of the atmosphere. Also, the products of combustion can be separated from the mixture before the mixture is passed to the end user. Further, the unspent fuel, primarily in the form of hydrocarbons, from the engine 14 is not wasted, but rather is added to the product gases in the line 12 for use by the end user.

It is understood that variations may be made in the foregoing without departing from the scope of the invention. For example, the particular designs of the compressor 10 and the engine 14 can be varied. Also, the engine 14 can be powered by fuel, such as diesel or gasoline, from a source other than the line 12. Further, the branch line 12a and the pipe, or conduit, 20 can be connected to the line 12 at locations that are different from those shown in the drawings. Still further, the products of combustion from the engine 14 can be separated from the remaining portion of the above mixture before the mixture is compressed. Moreover, the terms “flow line”, “branch line”, “pipe”, “riser”, and “conduit” have been used interchangeably, and it is understood that all refer, in general, to any device that permits the flow of fluid therethrough.

Although only one exemplary embodiment has been described in detail above, those skilled in the art will readily appreciate that many other variations and modifications are possible in the exemplary embodiment described above without materially departing from the novel teachings and advantages of this invention. Accordingly, all such variations and modifications are intended to be included within the scope of this invention as defined in the following claims. In the claims, means-plus-function clauses are intended to cover the structures described herein as performing the recited function and not only structural equivalents, but also equivalent structures.

1-19. (canceled)

20. A pollution control method, the method comprising:
providing gas in a first flow line;
connecting the first flow line to a compressor for supplying gas to the compressor;
connecting a second flow line between the first flow line and a combustion engine for supplying gas to the engine to power the engine;
driving the compressor by the engine so that the compressor compresses the gas received by the compressor; and
passing the products of combustion and the unspent fuel from the engine to the first flow line downstream of the connection of the second flow line to the first flow line so that the products of combustion and the unspent fuel material mix with the gas before the mixture enters the compressor.

21. The method of claim 20 further comprising separating the products of combustion and the unspent fuel from the gas after the mixture passes through the compressor.

22. The method of claim 21 further comprising passing the separated gas to an end user.

23. A pollution control method, the method comprising:
providing gas in a first flow line and in a second flow line;
connecting the first flow line to a compressor for supplying gas to the compressor;
connecting the second flow line to a combustion engine for supplying gas to the engine to power the engine;
driving the compressor by the engine to compress the gas received by the compressor; and
passing the compressed gas to an end user.

24. The method of claim 23 wherein the first flow line is connected to a source of the gas and wherein the second flow line is connected between the first flow line and the engine.

25. The method of claim 24 further comprising passing the products of combustion and the unspent fuel from the engine to the first flow line downstream of the connection of the second flow line to the first flow line so that the products of combustion and the unspent fuel material mix with the gas before the mixture enters the compressor.

26. The method of claim 25 further comprising separating the products of combustion and the unspent fuel from the gas after the mixture passes through the compressor.

27. The method of claim 26 further comprising passing the separated gas to an end user.

28. A pollution control system, the system comprising:
a first flow line containing gas;
a compressor connected to the first flow line for receiving the gas and compressing the gas;
a combustion engine operatively connected to the compressor for driving same;
a third flow line extending from the engine to the first flow line downstream of the connection of the second flow line to the first flow line so that the products of combustion and the unspent fuel material from the engine mix with the gas in the first flow line before the mixture enters the compressor.

29. The system of claim 28 further comprising a separator for separating the products of combustion and the unspent fuel from the gas after the mixture passes through the compressor.

30. The system of claim 29 further comprising a fourth flow line extending from the separator for passing the separated gas externally of the system.

31. A pollution control system, the system comprising:
a first flow line for receiving gas;
a second flow line for receiving gas;
a compressor connected to the first flow line for receiving gas from the first flow line;
a combustion engine connected to the second flow line for receiving gas to power the engine;
means for operatively connecting the engine to the compressor for driving the compressor and compressing the gas received by the compressor; and
means for passing the compressed gas externally of the system for use by an end user.

32. The system of claim 31 wherein the first flow line is connected to a source of the gas and wherein the second flow line is connected between the first flow line and the engine.

33. The system of claim 32 further comprising a third flow line extending from the engine to the first flow line for passing the products of combustion and the unspent fuel from the engine to the first flow line.

34. The system of claim 33 wherein the third flow line is connected to the first flow line downstream of the connection of the second flow line to the first flow line so that the products of combustion and the unspent fuel material mix with the gas before the mixture enters the compressor.

35. The system of claim 34 further comprising a separator for separating the products of combustion and the unspent fuel from the gas after the mixture passes through the compressor.

36. The system of claim 35 further comprising a fourth flow line extending from the separator for passing the separated gas externally of the system.
